(19) United States
(12) Patent Application Publication
(10) Pub. No.: US 2025/0305833 A1
(43) Pub. Date: Oct. 2, 2025

(54) SENSOR-AGNOSTIC INDOOR LOCALIZATION FRAMEWORK

(71) Applicant: NEC Laboratories America, Inc., Princeton, NJ (US)

(72) Inventors: Ravi Kailasam Rajendran, Colonia, NJ (US); Murugan Sankaradas, Dayton, NJ (US); Srimat Chakradhar, Manalapan, NJ (US)

(21) Appl. No.: 19/097,273

(22) Filed: Apr. 1, 2025

Related U.S. Application Data
(60) Provisional application No. 63/572,990, filed on Apr. 2, 2024.

(51) Int. Cl. G01C 21/20; G01C 5/06; G01C 21/16; G01S 13/02; G01S 13/42; H04W 4/33; H04W 60/00

(52) U.S. Cl. CPC G01C 21/206; G01C 5/06; G01C 21/1652; G01S 13/0209; G01S 13/42; H04W 4/33; H04W 60/00

(57) ABSTRACT

Systems and methods for sensor-agnostic indoor localization. The localization including locating a target object in an indoor space by employing sensors of different modalities, converting data from the sensors of different modalities into a single modality by employing a sensor-agnostic modality converter, and determining from the data in the single modality a range of the target object from a fixed point to locate a position of the target object within the indoor space.

### RELATED APPLICATION INFORMATION

This application claims priority to U.S. Provisional Patent Application 63/572,990, filed on Apr. 2, 2024, incorporated herein by reference in its entirety.

### BACKGROUND

### Technical Field

The present invention relates to navigation systems for indoor spaces and more particularly developing a data modality agnostic framework for indoor positioning and navigation services.

### Description of the Related Art

Positioning systems like Global Positioning System (GPS) have developed to be highly accurate and comprehensive but have limitations. In particular, GPS is less effective when there are obstructions between the end-device and the satellites the system is in communication with. Satellites and end-devices receive and send signals from one another for the GPS to operate correctly. This is hampered by physical materials blocking signals from being sent or received effectively.

To address this problem, Indoor Positioning System (IPS) has been developed. IPS uses sensors to replicate the functionalities of GPS without using satellites. However, each IPS system uses different sensor modes which are selected for various situations that each sensor is best suited for. For example, IPS can be used in navigation, asset tracking, and emergency response situations, etc., with each use case leveraging the benefits a given sensor type or modality of sensors.

IPS, while solving problems of GPS, also suffers from problems. IPS is not standardized, meaning each implementation of IPS is unique and specially configured for the indoor space the IPS is being used in. The problems that are caused by this inconsistency can include system inflexibility, lack of scalability, and inability to anticipate future needs. IPS may also suffer because the modality types for sensor data selected for IPS may change over time, cost considerations can change, indoor space shape and configuration can change, and new technologies can be developed which are not contemplated in legacy IPS systems.

### SUMMARY

According to an aspect of the present invention, a method for indoor localization is provided. The method includes locating a target object in an indoor space by employing sensors of different modalities, converting data from the sensors of different modalities into a single modality by employing a sensor-agnostic modality converter, and determining from the data in the single modality a range of the target object from a fixed point to locate a position of the target object within the indoor space.

According to another aspect of the present invention, a system is provided for an indoor localization. The system includes locating a target object in an indoor space by employing sensors of different modalities, converting data from the sensors of different modalities into a single modality by employing a sensor-agnostic modality converter, and determining from the data in the single modality a range of the target object from a fixed point to locate a position of the target object within the indoor space.

According to yet another aspect of the present invention, a computer program product is provided. The computer program product includes a non-transitory computer-readable storage medium containing computer program code. The computer program code when executed by one or more processors causes the one or more processors to perform operations, the computer program code including instructions to locate a target object in an indoor space by employing sensors of different modalities, convert data from the sensors of different modalities into a single modality by employing a sensor-agnostic modality converter, and determine from the data in the single modality a range of the target object from a fixed point to locate a position of the target object within the indoor space..

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level system for the sensor agnostic localization framework in accordance with an embodiment of the present invention;

FIG. 2 is a flow diagram illustrating the system for the sensor agnostic localization framework in more detail, in accordance with an embodiment of the present invention;

FIG. 3 is a flow diagram illustrating a system for collecting, processing, and visualizing sensor data, in accordance with an embodiment of the present invention;

FIG. 4 is a detailed block diagram of the sensor-agnostic modality converter, in accordance with an embodiment of the present invention;

FIGS. 5 and 6 illustrate a detailed block diagram of the IPS framework, in accordance with an embodiment of the present invention;

FIG. 7 is a block diagram of a scene implementing the IPS framework, in accordance with an embodiment of the present invention;

FIGS. 8-9 are a block diagram illustrating a high-level method for the IPS framework in accordance with an embodiment of the present invention; and

FIG. 10 is a block diagram illustrating a computer environment implementing the IPS framework in accordance with an embodiment of the present invention.

### DETAILED DESCRIPTION OF PREFERRED EMBODIMENTS

An IPS framework can collect and aggregate data from various sensors concerning a target object, where the sensors have various modalities. Once aggregated, the data from the sensors can be converted into a single modality. The data in the single modality can then be formed into a range (distance) and angle of the target object relative to a fixed point or fixed set of points. Using a single modality, the IPS framework can then locate a user or target object using techniques such as triangulation, trilateration, etc. Then, once the user or target object are located, the IPS framework can use information for services such as, e.g., navigation, mapping, and tracking, etc.

Various sensor technologies have been explored for use in IPS, each with advantages and limitations. Wi-Fi® utilizes existing infrastructure for Received Signal Strength Indication (RSSI) based indoor localization, but Wi-Fi® suffers from multi-path effects and network dependency. Bluetooth Low Energy (BLE) offers low power consumption and is suitable for tracking fixed and mobile assets but has a limited range and uses pre-installed beacons. Ultra-Wideband (UWB) provides high accuracy but is expensive and depending on frequency band of operation, coverage area varies. Other sensor technologies include other electromagnetic frequencies such as Zigbee® and near field communication (NFC), inertial sensors like accelerometers, gyroscopes, magnetometers, and inertial measurement units (IMUs), dead reckoning enabled devices, infrared sensors, ultrasound sensors, magnetic field mapping, magnetic field fingerprinting, camera and video based sensors such as RGB-D and Light Detection and Ranging (LiDAR), laser range finders, barometric pressure sensors, environmental sensors such as temperature and humidity sensors, long range (LoRa®), radio frequency identification (RFID), sound navigation and ranging (SONAR), etc.

An IPS framework to aggregate different sensor technologies and integrate them seamlessly addresses the limitations of these technologies individually. Converting different sensor data modalities to a single form to render many of these issues moot by allowing the IPS to change sensors with minimal reconfiguration. This makes the IPS framework sensor-agnostic. A modality agnostic IPS framework can allow the indoor space and/or sensors to be adapted without concern of IPS adaptability to the change.

In accordance with an embodiment of the present invention, IPS can be used to serve as a navigation tool for new and/or large indoor spaces such as airports or convention halls. In another embodiment, IPS can be used in asset tracking to prevent theft in commercial settings by continuously tracking assets. In even further embodiments, IPS can facilitate easier, simpler, and quicker commercial transaction interactions by tracking assets from inventory until the asset is removed from the store. The IPS can prompt the retailer to automatically charge the consumer the cost of the goods taken or services rendered.

Other embodiments also contemplate emergency response personnel using IPS to quickly navigate large, complicated, or unfamiliar locations to reach the desired location quickly. Similarly, in embodiments IPS can also assist emergency personnel navigate when there are obstructions to visibility such as darkness, or smoke or another particulate in the atmosphere. Other embodiments for IPS include use in athletic competitions. For example, IPS can track the time of athletes in competitions or allow sports leagues to verify “calls” with high precision and accuracy like if players or objects (e.g., balls, pucks, disks) are within boundaries or in accordance with other regulations.

IPS can be categorized into two approaches (1) infrastructure-based localization, which relies on pre-installed sensors at predetermined locations in the environment and (2) infrastructure-free localization, which deploys sensors on-demand. Infrastructure-based localization offers good accuracy but there may be significant initial investment and may not be scalable for dynamic environments. Infrastructure-free localization often has complex on-site calibration and is susceptible to lower accuracy. To overcome these limitations and enable seamless deployment across practical scenarios, having a framework which is agnostic to sensors and algorithms used can be useful.

This framework handles the heterogeneity of sensor data. For example, some sensors measure received signal strength indicator (RSSI), while others provide range estimates or link quality indicators. Alternatives to RSSI include time of flight (ToF), angle of arrival (AoA), time difference of arrival (TDOA), triangulation, trilateration, round trip time (RTT), fingerprinting, magnetic positioning, computer vision (CV), acoustic positioning, etc.

Unifying these data modalities into a common framework allows for the development of a more robust indoor localization system. The framework can be modular, allowing for rapid testing and deployment and easy integration of new sensor types and functionalities with minimal modification to the core system. The framework also enables a user to consider various technologies for maintenance and cost reasons, achieve high accuracy, and function on spaces including several floors of a single indoor space.

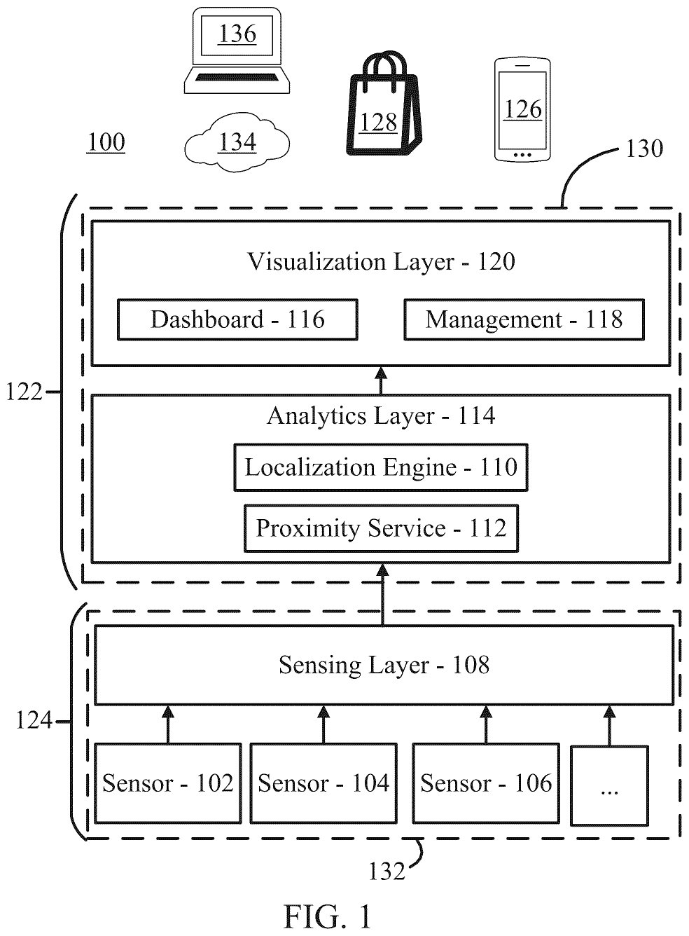

Referring now in detail to the figures in which like numerals represent the same or similar elements and initially to FIG. 1, a high-level block diagram for the sensor agnostic localization framework is illustratively depicted in accordance with one embodiment of the present invention. The IPS framework 100 has three layers, which facilitate easy decoupling and deployment.

A sensing layer 108 can operate on battery-powered, resource-constrained end-devices 126, gathering measurements for transmitting data. Sensing layer 108 can determine the location of a target object 128. Sensing layer 108 can also include components on the target object 128 as well as stationary components. The target object 128 can be a user or product which is being located, identified, navigated, or tracked. The target object 128 can be animate or inanimate and may emit signals detected by sensors 102, 104, 106. In other embodiments, the target object 128 does not emit any signals. End-devices 126 can be one or more physical devices. In an embodiment end-devices 126 can measure different sensing modalities. For example, an end-device can have a sensor 102 which senses Wi-Fi®, while a sensor 104 uses BLE and a sensor 106 uses IMUs.

In other embodiments combinations of sensors 102, 104, 106 can use the same technology. The sensors 102, 104, 106 can also be connected to the indoor spaces power supply in some embodiments instead of using batteries. In some embodiments, a single end-device 126 can be capable of sensing several modalities simultaneously, e.g. sensor 102 and sensor 104 can be housed in the same end-device 126.

Sensors 102, 104, 106 can be part of beacon 132. The sensors 102, 104, 106 can function either as a static beacon 132 for tracking fixed assets (e.g., machinery) or a mobile beacon 132 for personnel or mobile asset tracking.

One function of the sensing layer 108 is to collect measurements. These measurements can be range measurements (e.g. distances between end-devices 126 in the vicinity from one another and beacons 132) angle measurements (e.g. angles between end-devices 126 from one another and beacons 132), inertial measurements (motion data), and barometric measurements (altitude data). These measurements are then reported to a central controller 130 for further processing and localization estimation.

This central controller 130 can include analytics layer 114. Beacons 132, which communicate with one or more sensors 102, 104, 106, can be highly configurable and programmable relay devices which integrate the sensors 102, 104, 106 with the central controller 130. Beacons 132 can be configured and programmed after deployment and installation through the central controller 130. This flexibility in configuration is useful for various functionalities, including the discovery of new beacons 132 within the network which enables seamless expansion and integration of new end-devices 126. Moreover, scheduling allows efficient communication with other nearby beacons 132, optimizing resource utilization and minimizing interference. Additionally, setting reporting intervals for range measurements can ensure timely and accurate data collection.

Furthermore, the capability to report status measurements is useful for IPS framework 100 monitoring and maintenance, encompassing aspects such as heartbeat information for assessing beacon 132 liveness, battery status to preemptively address power concerns, and connectivity status for ensuring uninterrupted data transmission. Beacons 132 can establish connectivity with the central controller 130 via Wi-Fi® or 5G Internet of Things (IoT). This data connectivity is useful for orchestrating operations, managing configurations, and facilitating efficient communication within the IPS framework 100. Beacon 132 liveliness can include signal strength, ability to constantly transmit data or transmit data in time intervals, beacon 132 battery level, and beacon 132 settings (e.g. to actively emit signals or passively emit signals in response to receiving a signal or end-devices 126 becoming in range).

The IPS framework 100 can incorporate a suite of modular sensors 102, 104, 106, with ranging sensors 102, 104, 106 like UWB, BLE, LiDAR, or Wi-Fi® as components for distance measurement. Additionally, beacons 132 can optionally integrate sensors 102, 104, 106 to detect pressures (altimeters and/or barometers) or inertia (IMUs) to further enhance localization accuracy. The IPS framework 100 can leverage the central controller 130 to implement a dynamic scheduling policy. This policy can dictate which ranging sensor 102, 104, 106 on beacon 132 actively measures distance with nearby beacons 132. The scheduling decision considers factors like sensor 102, 104, 106 features (e.g. one-way vs. two-way ranging, time synchronization requirements) and sensor 102, 104, 106 deployments within the IPS framework 100. By dynamically adjusting the scheduling policy based on the available sensor 102, 104, 106 suites, the IPS framework 100 can optimize ranging efficiency, leverage the strengths of different sensors 102, 104, 106 modalities, and enable improved localization accuracy.

Sensors 102, 104, 106 and sensing layer 108 can be considered a sensing group 124. Sensing group 124 can be housed on end-devices 126 dispersed throughout the indoor space. Alternatively, sensing group 124 can be configured to be integrated with other components of the IPS framework 100.

The IPS framework 100 has an analytics layer 114, which can be a cloud server 134 or a hosted server 136. In other embodiments however, other computing types are contemplated such as edge computing or fog computing. Analytics layer 114 can discover nearby end-devices 126 such as beacons 132 and sensors 102, 104, 106 and execute localization functions. The local end-devices 126 are discovered by proximity service 112. Proximity service 112 facilitates accurate location tracking within the IPS framework 100 through neighborhood discovery.

Localization engine 110 resides in central controller 130 and executes localization functions. The localization engine 110 is responsible for estimating locations of mobile beacons 132, detection devices, and sensors 102, 104, 106 based on available data, this process can be performed in real-time in some embodiments.

A visualization layer 120 serves as an interface allowing users to adjust the IPS framework's 100 operational parameters and obtain information about the location of mobile beacons 132. The user can interface with the IPS framework 100 with dashboard 116. The dashboard interacts with management 118 which can communicate with analytics layer 114 and sensing layer 108 in some embodiments. Visualization layer 120 provides tools for managing the IPS framework 100, real-time data monitoring, and sensor 102, 104, 106 administration.

Analytics layer 114 and visualization layer 120 can be considered a computing group 122. Computing group 122 can be executed and housed in several locations, e.g., cloud computing, or in a single place, e.g. a hosted server. Computing group 122 computes the information for the IPS framework 100 received from sensing group 124.

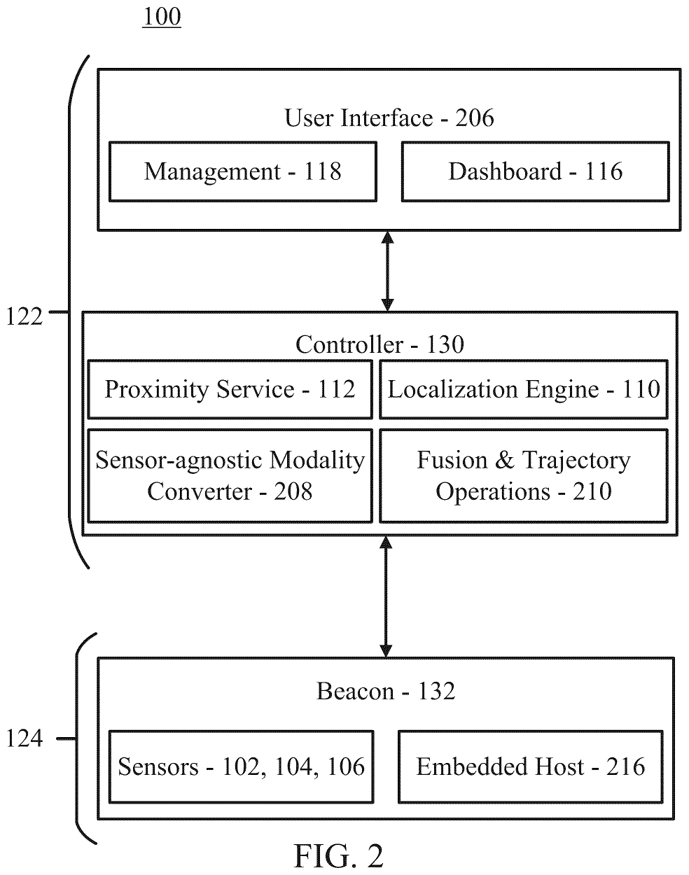

Now referring to FIG. 2, a more detailed block diagram of IPS framework 100 is now shown in accordance with an embodiment. IPS framework 100 has one or more beacons 132 that include sensors 102, 104, 106. In some embodiments, beacon 132 has many end-devices 126 and in other embodiments, there is one end-device 126 in beacon 132. Also within beacon 132 is embedded host 216. Embedded host 216 communicates with other beacons 132 and other portions of IPS framework 100 such as computing group 122. Beacon 132 is within sensing group 124.

Computing group 122 includes controller 130 and user interface 206. Within controller 130 is proximity service 112, localization engine 110, sensor-agnostic modality converter 208 and fusion and trajectory operations 210. Sensor-agnostic modality converter 208 receives data from beacons 132 with different sensors 102, 104, 106 which provide metrics to the localization process. Ranging sensors 102, 104, 106 like, e.g., UWB and LiDAR directly measure the distance between devices, providing absolute distance information. Sensors 102, 104, 106 like Wi-Fi® and Bluetooth offer RSSI readings, which can be processed into range measurements prior to estimating distances. In some embodiments, sensors 102, 104, 106 collect data on advanced signals like UWB and can provide angular data in the form of azimuth and elevation relative to their own position for additional information.

Raw sensor 102, 104, 106 measurements are susceptible to errors caused by various factors like noise, interference, or environmental conditions which can be mitigated by using multiple modalities that can avoid the measurement errors of other modalities.

Pre-processing techniques like dynamic time window averaging and outlier removal enhance the data quality of raw sensor 102, 104, 106 measurements. The sensor-agnostic modality converter 208 can use sampling to ensure consistent data acquisition from sensors 102, 104, 106, clipping to remove outlier values that fall outside a predefined range (thereby mitigating the impact of sudden spikes or dips in the data), and smoothing to remove high-frequency noise and create a smoother representation of the underlying signal. Once the measurements are pre-processed, the data is converted into range and angle data in the sensor-agnostic modality converter.

In an embodiment, data is converted into measurements distance from ToF. In instances when angle data is available, AoA data can be incorporated into the sensor-agnostic modality converter. Other data modalities like RSSI can be converted into another form before being processed by the localization engine 110. RSSI and other modalities can be transformed into distance measurements through signal processing techniques such as path loss estimation. Other signal processing techniques are also contemplated.

Time of flight (ToF) can include measuring the time for a signal to be emitted and received by a beacon 132 which is related to the distance from the target object 128 (FIG. 1) and the speed of the signal. In different modalities and configurations, the ToF can be calculated in various ways, known to those of ordinary skill in the art. The angle of arrival (AoA) can be calculated using the time difference between when a signal reaches antenna elements or, alternatively, phase difference received by antenna elements. Alternative embodiments to calculate the AoA are also contemplated.

The IPS framework 100 can use any type of data modality because the sensor-agnostic modality converter 208 can make the data agnostic to the original modality type and form. In an embodiment, the single modality the sensor-agnostic modality converter 208 converts the data into can be UWB, which applies ToF based ranging. UWB also has angle data capabilities. In some embodiments, only range data is available. In other embodiments, only angle data is available or both range and angle data are available.

Fusion and trajectory operations 210 use the angle and range data to determine trajectories. Fusion and trajectory operations 210 can also leverage ranging sensors 102, 104, 106 like LiDAR, UWB, or Bluetooth for distance measurements between mobile beacons 132 and static reference points (anchors). While these detection devices can provide distance information, accuracy can be compromised by real-world challenges like, non-line-of-sight, obstructions, wave propagation effects, and multi-path reflections which can lead to erroneous ranging data. Consequently, relying on sensors 102, 104, 106 of the same modality for location estimates can result in inaccuracies. IPS framework 100 can incorporate sensor fusion techniques that combines data from ranging sensors 102, 104, 106 with other beacons 132 to mitigate these issues.

For example, in some embodiments, these issues can be mitigated by incorporating IMU sensors 102, 104, 106 to supplement UWB sensors 102, 104, 106. When UWB data is temporarily unavailable, IPS framework 100 can primarily rely on IMU data until a connection between controller 130 and beacon 132 can be restored. IMU data also reduces errors in IPS framework 100 even when UWB data is available. IMUs capture a mobile beacon's 218 motion data (acceleration, rotation, etc.). By fusing ranging data with IMU data using linear tracking algorithms like Kalman Filtering (KF), IPS framework 100 can refine the location estimates accuracy. The deployment strategy for beacon 132 anchors aids in determining the dimensionality of ranging measurements and the overall accuracy of multi-floor tracking.

In one embodiment, IPS framework 100 can have floor-wise anchor deployment. During floor-wide anchor deployment, anchors are positioned on each floor of the building. Ranging measurements in this case are limited to two dimensions (x and y) due to the single-floor coverage area of the anchors. Barometric sensor 102, 104, 106 data from mobile beacons 132 can be fused with location data to enable accurate multi-floor tracking.

In other embodiments, IPS framework 100 can have facility-level anchor deployment. Sensing technologies like LoRa® offer wider coverage areas and reduced signal attenuation, enabling anchor deployment outside the indoor space. Using facility-level anchor deployment may not have anchors on every floor. During facility-level anchor deployment, location estimates obtained through ranging become three-dimensional (x, y, and z), capturing vertical distances across floors as well as horizontal distances.

Barometric sensor 102, 104, 106 data may be useful in differentiating between different floors in the indoor space. IPS framework 100 can address this by utilizing fusion algorithms. For example, indoor spaces with similar or the same floor plan on several floors may identify which level (floor) beacon 132 is on based on the pressure barometric sensor 102, 104, 106 is measuring. The pressure (or a range of pressures) can be affiliated with a floor. Using this data along with the other information obtained from beacons 132 can locate the target object 128 (FIG. 1). These algorithms incorporate the three-dimensional (3D) distance measurements alongside barometric sensor 102, 104, 106 data from the mobile beacons 132. This combined approach refines altitude estimates and facilitates accurate location tracking across multiple floors. The barometric data can be cross-referenced with a range of pressures typical to the floor. This can be done through artificial intelligence or pre-loaded reference data. In another embodiment, the barometric data can compare differences in pressure of barometric data with other data collected within IPS framework 100 instead of using absolute values. This latter embodiment can be useful in locations where the ambient air pressure can vary.

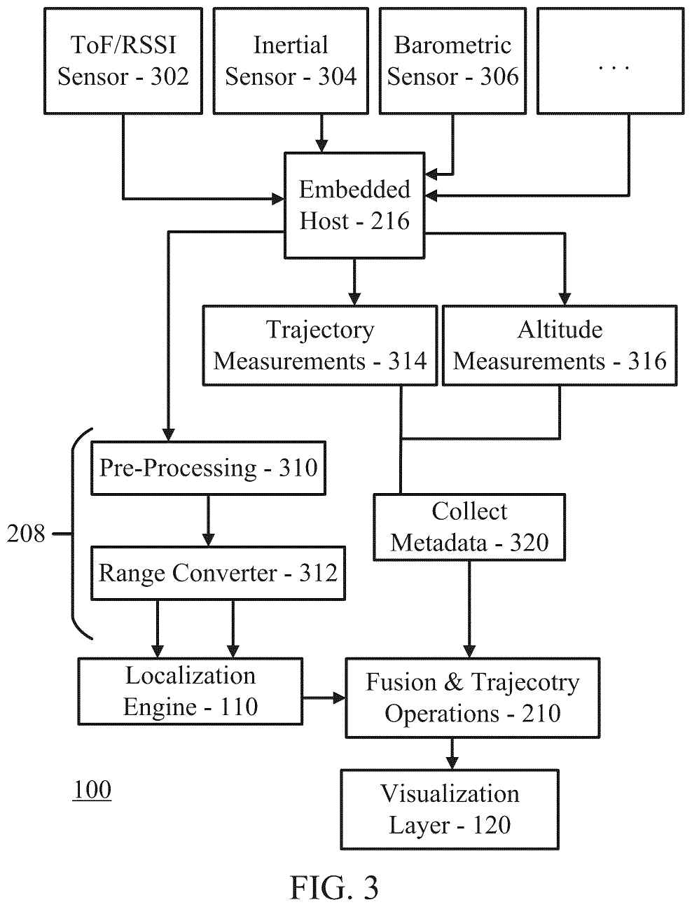

Now referring to FIG. 3, a flow diagram of the IPS framework 100 is demonstrated according to an embodiment. ToF/RSSI sensor 302 collects data of electromagnetic radiation (in particular, radio waves) and determines metadata once the data is received and processed by localization engine 110. This distance can be determined by metadata techniques concerning the transmission such as RSSI, ToF, AoA, TDOA, etc. Inertial sensor 304 can be located on the end-device 126 (FIG. 1). The inertial sensor 304 can record and transmit data regarding device positioning, velocity, and acceleration. In other embodiments, other physical attributes about the device can also be measured. Barometric sensor 306 measures the pressure of a given location. Barometric sensor 306 can determine the floor of the indoor space and whether the user has stepped on a portion of the floor associated with the barometric sensor. Other types of sensors such as thermometers can be used in other embodiments. ToF/RSSI sensor 302, inertial sensor 304, and barometric sensor 306 send data to embedded host 216, the data is then sent to pre-processing 310, trajectory measurement 314, and altitude measurement 316 respectively. In some embodiments, the data from one modality can be received and processed by another component. For example, inertial sensor 304 can send data to be processed in pre-processing 310.

Pre-processing 310 and ranger converter 312 make up sensor-agnostic modality converter 208. The ranger converter 312 standardizes various sensing modalities by converting them into distance estimates for localization. In some embodiments, ranger converter 312 can directly use ToF-based measurements as well as depth-based, and inertial data as they can be used for location estimation. Modalities like RSSI can be converted to distance using a path loss estimation model prior to being used in further components.

Path loss estimation can ensure measurements are in a uniform distance-based format (e.g. converting several modalities into a single modality) and provides seamless integration into the localization engine 110. The ranger converter 312 handles diverse inputs and ensures consistency for accurate position estimation. The sensor-agnostic modality converter 208 can output both range and angle information to localization engine 110. Trajectory measurements and altitude measurements 316 provide metadata to collect metadata 320. Localization engine 110 and collect metadata 320 both input data into fusion and trajectory operations 210. The data can be output to visualization layer 120.

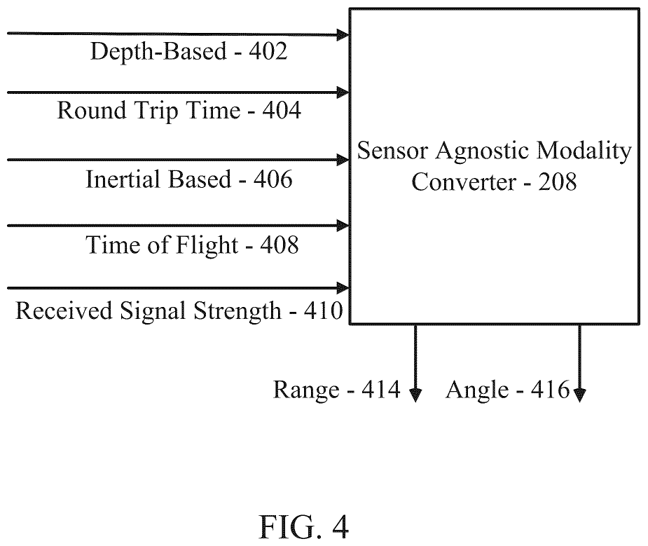

Now referring to FIG. 4, a more detailed block diagram of the sensor-agnostic modality converter 208 is shown, in accordance with an embodiment. Sensor-agnostic modality converter 208 can receive a variety of data modalities. The modalities input into sensor-agnostic modality converter 208 can be depth-based 402, RTT 404, inertial based 406, ToF 408 and RSSI 410. Other modalities are also contemplated such as TDOA, AoA, etc. The sensor-agnostic modality converter 208 then uses information from these modalities to output modality agnostic information. In an embodiment, sensor-agnostic modality converter 208 can convert the data in different modalities into ToF. This can be performed using techniques such as path loss estimation. Other algorithms are also contemplated to convert the data into ToF or any other single modality. Data can also be converted into AoA in an embodiment. The output of sensor-agnostic modality converter 208 can be range 414 (distance) and angle 416. Various techniques can be used to determine range 414 and angle 416 including triangulation and trilateration.

The modularized IPS framework 100 for localization can separate sensing group 124 (FIG. 1) and computing group 122 (FIG. 1) into distinct layers, offering flexibility and enabling a plug-and-play feature for various sensors (sensing layers) and localization algorithms (analytics layers). To handle the heterogeneous sensing inputs, sensor-agnostic modality converter 208 standardizes the data before it reaches the analytic engine. Sensor-agnostic modality converter 208 dynamically adapts conversion models based on sensor 102, 104, 106 availability and environmental conditions to process the diverse input types and outputs range 414 and angle 416 measurements, which are then used for further processing by the localization algorithms.

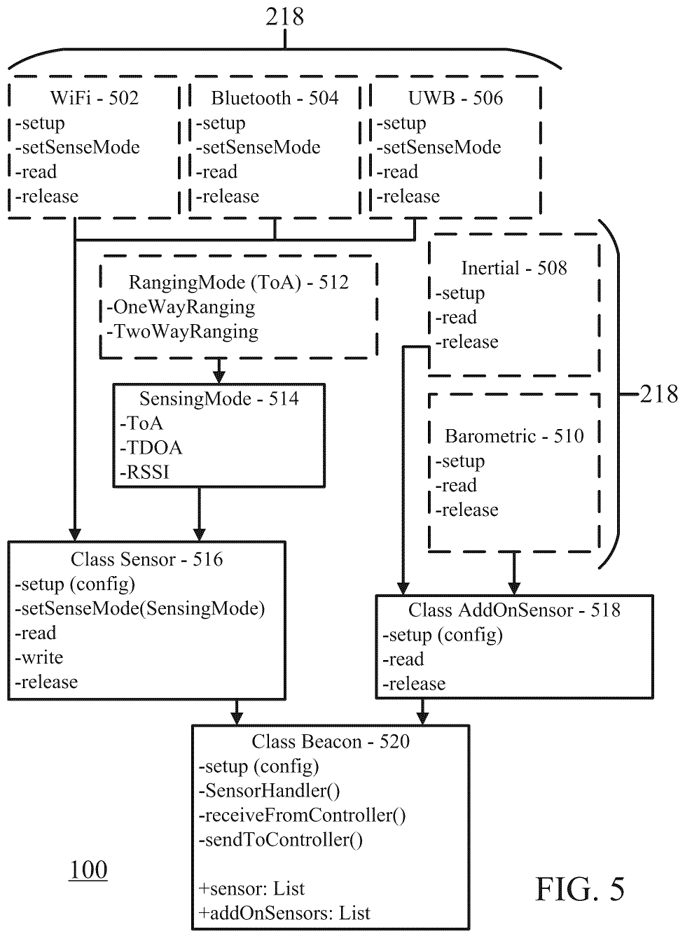

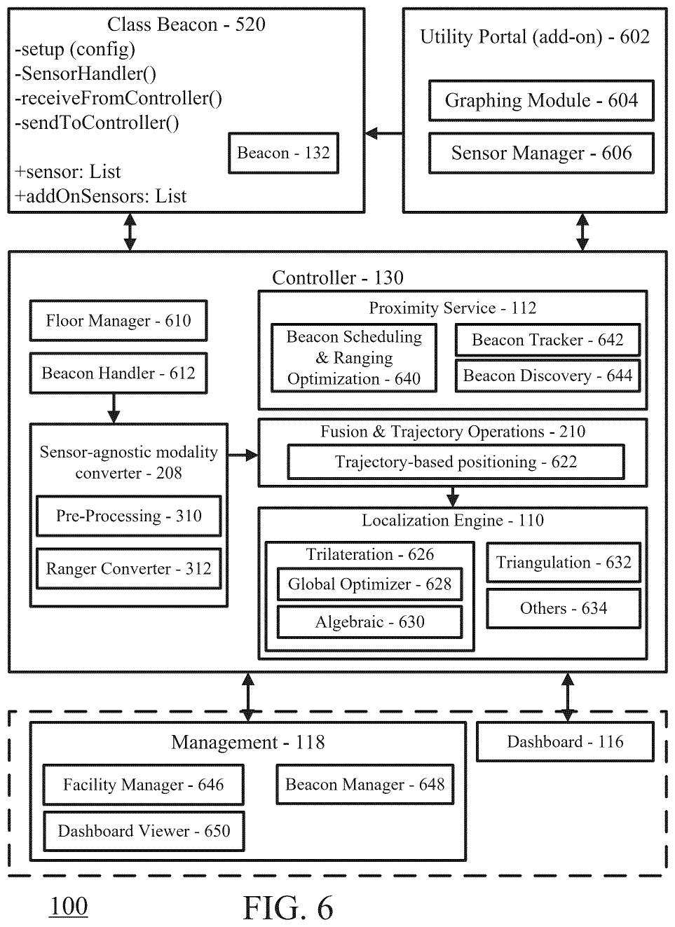

Now referring to FIGS. 5 and 6, a detailed block diagram of the IPS framework 100 is shown in accordance with an embodiment. FIG. 5 demonstrates the integration of the sensing layer 108 (FIG. 1). FIG. 5 shows pseudocode that each component uses in the IPS framework 100. Wi-Fi® modality 502, Bluetooth modality 504, UWB modality 506 emit different types of signal modalities with data concerning IPS framework 100. These signals are received by Class Sensor 516. RangingMode modality 512 which uses ToA modality is received by SensingMode 514. SensingMode then sends data to Class Sensor 516.

Inertial modality 508 and barometric modality 510 which rely on physical phenomena instead of metadata, like ToF, send data to Class AddOnSensor 518. Class AddOnSensor 518 and Class Sensor 516 then send information to Class Beacon 520.

FIG. 6 demonstrates the integration of sensing group 124 (FIG. 1) with computing group 122 (FIG. 2) in greater detail. Class beacon 520 shares information with controller 130. Controller 130 includes beacon handler 612 which is the central control point for beacon communication and management. Beacon handler 612 establishes and maintains connections with individual beacons 132 within the IPS framework 100, ensuring reliable data exchange. Beacon handler 612 has a liveness monitoring feature. Regular “heartbeat” signals are exchanged between beacons 132 and the controller 130 through the beacon handler 612. These heartbeat signals serve as a liveness check, allowing the IPS framework 100 to identify and address any potential beacon malfunctions or out-of-range situations.

The beacon handler 612 can also serve to register and deregister beacons 132. When beacon 132 enters the designated indoor space which IPS framework 100 is covering, and establishes communication, the beacon 132 registers with the controller 130. Additionally, beacons 132 departing the facility de-register, informing IPS framework 100 of their absence. Registering and deregistering beacons 132 can also performed manually.

Also within controller 130 is floor manager 610. In situations where the IPS framework 100 covers indoor spaces with multiple floors, altitude is a useful factor for accurate location tracking. Since the indoor space's elevation can vary across different locations, a robust approach is helpful to determine the floor level of mobile beacons 132. The IPS framework 100 utilizes barometric pressure sensors within mobile beacons in conjunction with a reference sensor (barometric modality 510) deployed on the ground floor. This reference provides a baseline for pressure and altitude measurements.

Mobile beacons 132 on different floors experience varying relative pressure levels compared to the ground-floor reference. By leveraging available metadata about the indoor space's individual floor heights, IPS framework 100 translates these relative pressure readings into floor levels. This translation process enables the IPS framework 100 to track mobile beacons 132 across multiple floors. Controller 130 assists in this process, maintaining a record of each beacon's 218 current altitude information and updating the information as the beacon 132 moves throughout the facility.

Now addressing the manner in which data is processed in controller 130, the information received from beacons 132 (e.g. from class beacon 520) and is input into beacon handler 612. The information is then sent to sensor-agnostic modality converter 208 for pre-processing 310 and ranger converter 312. Once the information is in a single modality the information is sent to fusion and trajectory operation 210. Within fusion and trajectory operation 210 is trajectory-based positioning 622 which processes inertial data to compute positioning data for IMU beacons 132. The positioning includes acceleration and angular velocity. Algorithms such as KF or dead reckoning can integrate IMU data to estimate position, velocity, and orientation. IMU sensors 102, 104, 106 (FIG. 1) track changes in motion, enabling trajectory reconstruction by continuously integrating acceleration to velocity and position. This information can be used by the IPS framework 100 to refine the location estimates.

Controller 130 can also be equipped with fail-safe mechanisms, such as localization engine 110 which can handle various scenarios and edge cases effectively. The data from fusion and trajectory operation 210 (which has a fusion framework for combining the data after the data has been converted to a single modality) is then sent to localization engine 110 which leverages a combination of algorithms depending on the types of sensor measurement available and in use. Localization engine 110 estimates the positions of beacons 132 (FIG. 1) using algorithms based on available modalities of data. When range 414 (FIG. 4) measurements are available, a range-based algorithm like multi-lateration is used. When angles 416 (FIG. 4) such as azimuth and elevation are provided, an angle-based algorithm like triangulation estimates the locations. In embodiments using RSSI, the sensor-agnostic modality converter 208 applies a path loss estimation model to convert RSSI to distance, which is then fed to the localization engine 110 to use range-based algorithms for localization.

For range-based data (e.g., distances between beacons), localization engine 110 employs trilateration 626 (3 known distances) or multi-lateration (more than 3 known distances) algorithms to estimate beacon locations. Trilateration can employ algebraic solutions 630 and global optimization from global optimizer 628. Additionally, if angle 416 (FIG. 4) measurements are incorporated (e.g., from directional antennas), triangulation 632 algorithms are utilized. Other methods 634 of localizing beacons 132 are also contemplated such as dead reckoning, fingerprinting, simultaneous localization and mapping (SLAM), inertial navigation system (INS), magnetic localization, visual odometry, ToA, and TDOA. Localization engine 110 offers two approaches for location computation, individual and global per-floor. IPS framework 100 provides flexibility to alternate between these approaches when desired or have IPS framework 100 do so automatically. This allows users to select the method that best suits the specific deployment scenario and data availability.

Proximity service 112 has functionalities which include beacon discovery 644, beacon tracker 642, and beacon scheduling and ranging optimization 640. Beacon discovery 644 and beacon tracker 642 can continuously identify the current locations of beacons 132. This may be in timed intervals or through constant communication. The functionality also maintains a record of locations visited for each beacon 132 on within the designated indoor space. Additionally, the functionality can actively track mobile beacons 132, leveraging both estimated locations and inertial data to enhance tracking accuracy. Furthermore, the proximity service 112 performs beacon discovery 644 in the neighborhood, identifying nearby beacons 132 to facilitate scheduling algorithms.

The scheduling component within the proximity service 112 is responsible for creating a dynamic plan for beacon 132 communication. The functionality may factor in the ranging budget of the IPS framework 100 to optimize communication efficiency while ensuring adequate data collection. The beacons 132 (FIG. 1) schedule and ranging optimization 640 transmits a list of potential nearby beacons 132 to each beacon 132, facilitating connections for ranging measurements. Upon receiving this list, beacons 132 reprogram their sensors 102, 104, 106 (FIG. 1) and establish ranging connections with designated neighbors within the allocated time interval. Then the beacons schedule and ranging optimization 640 tracks successful and unsuccessful connection attempts, updating its local database and optimizing the scheduling process for subsequent iterations. This continuous optimization can ensure efficient data collection and minimize unnecessary ranging attempts, which can lead to improved power consumption and overall IPS framework 100 performance.

Management 118 features a real-time location dashboard viewer 650 for visualizing the current locations of deployed beacons. Users can leverage filtering options to view specific beacons based on status or location. Management 118 also includes presenting real-time sensor measurements collected by the IPS framework 100 in beacon manager 648 which provides insights into various data streams in real-time, potentially including range measurements between beacons 132, inertial sensor data (for mobile beacons 132), and barometric data (for altitude).

Sensor manager 606 visualizes measurements in real-time, so uses can gain a deeper understanding of system dynamics and can identify any potential issues. Sensor manager 606 can also provide health information such as battery life, errors in signal sending or receiving and can indicate sensors that are not well placed. Facility manager 646 can manage the indoor space based on the information determined by the dashboard viewer 650 and beacon manager 648. For example, the indoor space can be secured once there is an indication that no users are present. Alternatively, the temperature of the indoor space can be increased if users are detected within the dashboard viewer 650 or beacon manager 648. In other embodiments, facility manager 646 can change heating, ventilation, electrical settings, air conditioning, security settings, use a public address (PA) system to navigate a user or make an announcement, interact with IoT devices, change lighting or shading, etc.

Dashboard 116 and management 118 can be a single portal. This portal allows users to manage various IPS framework 100 entities, including facilities, floors, and beacons. Management 118 functions include creating, modifying, and deleting these entities. For facilities, metadata like name, address, and number of floors can be specified. Floor definitions include details such as name, layout plan, and conversion factors to convert between pixels to meters (or feet). Beacon manager 648 allows users to add, edit, and delete beacons, along with assigning metadata that includes the beacon's name, designated facility, and unique beacon identifier. Additionally, anchors (fixed beacons) have associated floor information and their deployment location within that floor.

Real-time measurement (utility) portal 602 includes graphing module 604, which offers a feature to visualize measurements taken by a beacon at any given moment. This tool provides detailed information such as the measured distance between anchors and beacons 132, which other beacons 132 a given beacon 132 is ranging with at that moment, status of the localization solver (algorithms), whether support nodes are utilized and their coverage area, and the timestamp of the last seen communication.

Utility portal 602 manages the sensors 102, 104, 106 (FIG. 1) within the IPS framework 100 through sensor manager 606. Users can add edit, and delete sensors 102, 104, 106 (FIG. 1), along with configuring sensor parameters. The ability to monitor sensor health and status is useful for ensuring optimal IPS framework 100 performance. The utility portal 602 offers an additional advantage of having the ability to function in both online and offline modes.

In online mode, the IPS framework 100 retrieves latitude and longitude data from external APIs, enabling the visualization of beacon 132 locations on a geographical map. This can be seen in graphing module 604, which provides a broader context for understanding beacon deployment and real-time location data. When in offline mode, the IPS framework 100 relies on pre-configured data (e.g., floor plans) to display beacon locations within the designated facility. This ensures continued functionality even in scenarios with limited or no internet connectivity.

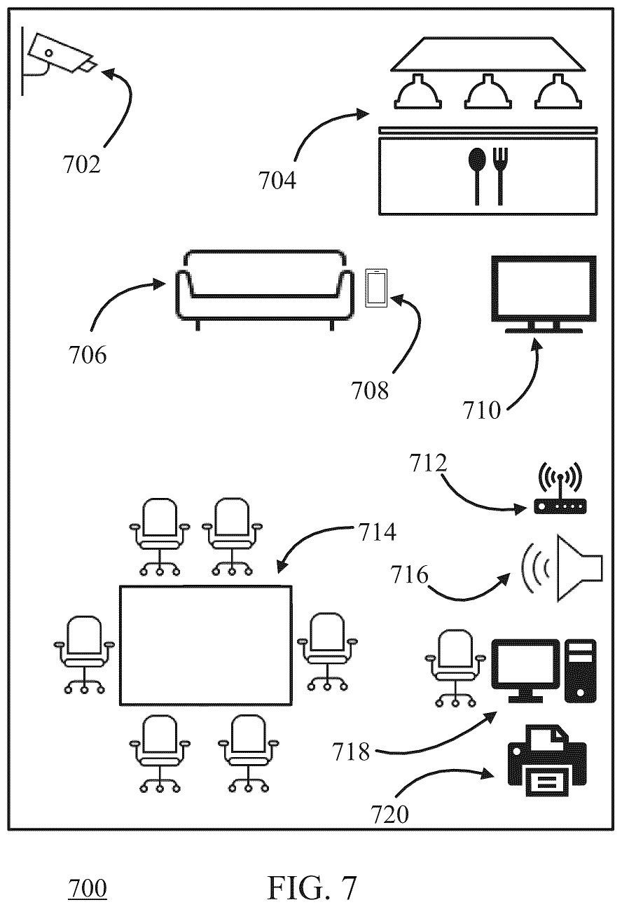

Now referring to FIG. 7, an illustration of IPS in use is demonstrated in accordance to an embodiment. Scene 700 depicts a situation where the IPS can be employed in to effectively track device 708. Camera 702 can use IR, visual spectrum, or other means to measure scene 700. In scene there can be food preparation area 704. Food preparation area 704 can create noise in the data for camera 702 by emitting IR radiation or visual motion that reduces the effectiveness of camera 702. Couch 706 can obstruct camera 702. Alternatively, and additionally, couch 706 can create obstacles or other modalities of data such as being a physical obstruction that reduces sensor range. Camera 702 can detect device 708. Alternatively, camera 702 can be programmed to identify a user.

Device 708 can be enabled to receive and emit BLE, Wi-Fi®, NFC, or other modalities of data. Device 708 can communicate with beacon 712. Beacon 712 can emit BLE, Wi-Fi®, or NFC. Television 710 can provide noise to the data in scene 700. Speaker 716 can be an ultrasonic speaker providing yet another modality of device 708 detection. Speaker 716 is located in a location not in view of camera 702 to improve the robustness of the IPS in scene 700. The noise from television 710 can be audio or radio frequency noise or both. Computer 718 can be a host server to the IPS in scene 700. Alternatively, or additionally, computer 718 can be an obstacle when detecting device 708. Printer 720 can also provide a visual obstacle or noise. Printer 720 can also be an IoT device and act as a sensor like beacon 712. Table 714 can house several users each with the device 708 (not depicted). The IPS in scene 700 can handle tracking several devices 708. Table 714 can also be a visual obstacle or obstacle for beacon 712.

IPS framework 100 (FIG. 1) can employ machine learning, computer vision, or other methods of employing artificial intelligence to optimize the identification of users and devices. In other embodiments, artificial intelligence can be used to optimize communication with IoT devices and beacons. The artificial intelligence can adapt to indoor spaces and modify frequencies when applicable. Sensors 102, 104, 106 (FIG. 1) can also be attached to motors or other mechanical devices to adapt to the indoor space. These mechanical devices can adjust the sensors 102, 104, 106 positioning such that the artificial intelligence network can optimize the IPS framework 100 (FIG. 1) for various considerations.

For example, the IPS framework 100 (FIG. 1) can be optimized for farthest range 414 and angle 416 (FIG. 4). This may make the intersection of collected data from sensors 102, 104, 106 minimal. In alternative embodiments, the optimization can be for most accurate and/or precise data collection which may include a greater intersection of collected data. The intersection of collected data may assist in sensor 102, 104, 106 calibration, data verification, and noise reduction. IPS can also work in outdoor spaces outfitted with the appropriate sensors 102, 104, 106 (FIG, 1). IPS can act as a localized GPS for outdoor spaces or spaces that include both indoor and outdoor components.

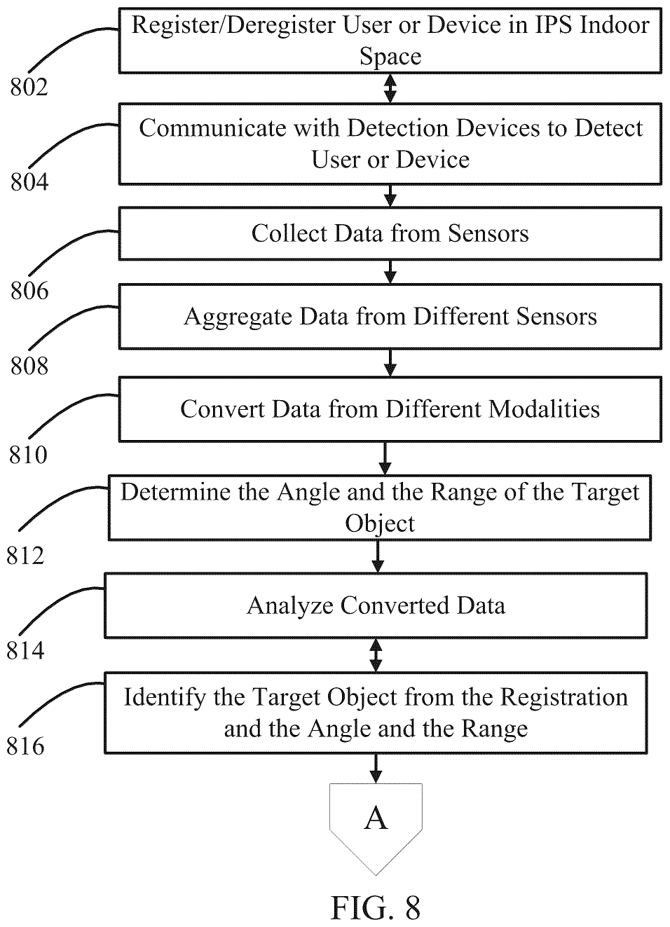

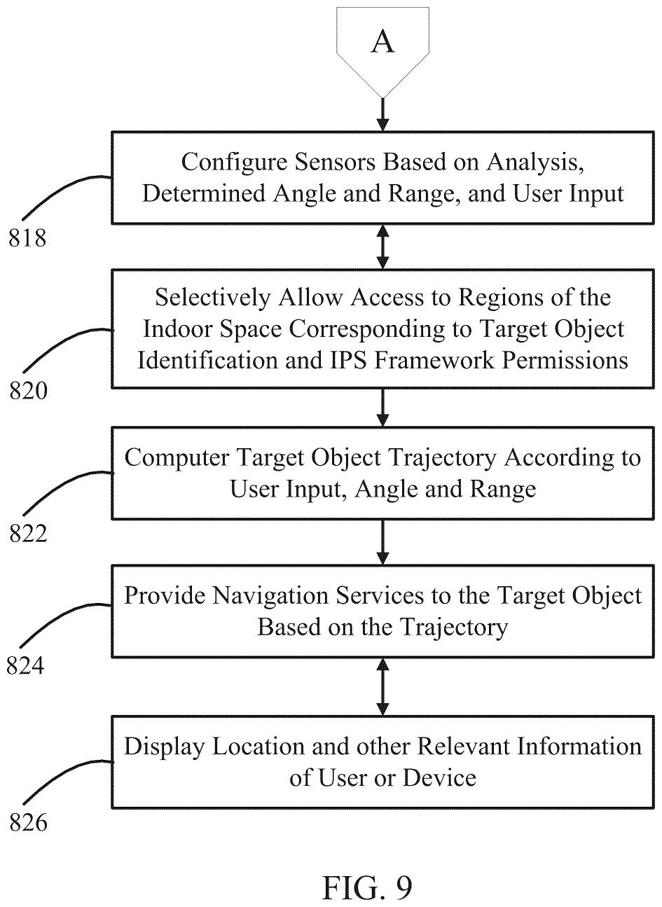

Now referring to FIGS. 8 and 9, a block diagram of IPS is demonstrated according to an embodiment. In Block 802, a user or device registers devices in the IPS indoor space. Registration and deregistration can occur automatically or can be a manual process. Security clearances or other types of access can be associated with registration levels. In other embodiments, the ability to be present in indoor spaces or accessibility to the IPS can be associated with registration.

In Block 804, the IPS can communicate with detection devices to detect the user or device in the indoor space of the IPS. The communication is to verify registration and access level. In Block 806, the IPS collects data in sensors. The data collected can be metadata, from IMUs, from barometric data, visual data, etc. In Block 808, the IPS aggregates data from different sensors 102, 104, 106 (FIG. 1). Aggregating data from sensors 102, 104, 106 (FIG. 1) includes collecting data from different modalities and/or the same modality. The data can be organized by type of data (radio frequency, physical phenomena, visual). In Block 810, the IPS converts data from different modalities. Converting data from data from different modalities into a single modality includes obtaining information from all the modalities and applying pre-processing techniques such as smoothing, etc., to ensure the data is reliable. In an embodiment ToF and AoA are selected for the single modality. In Block 812, the IPS determines the angle 416 and range 414 (FIG. 4) of the user or device. Determining the range 414 and angle 416 (FIG. 4) can use triangulation, trilateration, and other methods known in the art.

The output of the conversion can be either angle 416 or range 414 or both angle 416 and range 414 (FIG. 4). In other embodiments, other outputs are possible such as estimated time of arrival, estimated transit time, estimated time of complete, actual time of arrival, distance covered, distance traveled, route taken, etc.

In Block 814, the IPS analyzes the converted data. Analyzing the converted data can apply known analytical and mathematical solutions to process the data such as optimization of the system. In Block 814, the IPS can apply artificial intelligence techniques to improve the system and make recommendations for improvements to IPS. Artificial intelligence can include use artificial neural networks (ANNs) like recurrent neural networks (RNNs), convolutional neural networks (CNNs), etc. In Block 814 the IPS can also identify weaknesses and vulnerabilities of IPS in the particular indoor space. In Block 816, the IPS can identify the target object 128 (FIG. 1). Identifying the target object 128 (FIG. 1) can include using the information from the registration/deregistration. The identification can also include the angle 416 and range 414 data (FIG. 4). In other embodiments, the IPS can use neural networks with CNN or other algorithms to identify the target object, e.g., facial recognition programs or CNN. The user can also input identifying information into the IPS.

In Block 818, the user can configure sensors based on analysis, determined angle 416 and range 414 (FIG. 4), and user input. Sensors 102, 104, 106 and beacons 132 (FIG. 1) can be taken offline or put online based on user preferences or analysis. In other embodiments, beacons 132 (FIG. 1) can contain several methods of detection and alternate between modalities or use several modalities at once. In Block 818 there can be a neural network to optimize for a particular IPS in a particular situation. For example, a neural network can treat the indoor space beacons differently for a cocktail hour than at a business meeting. Focusing more on RSSI during the cocktail party than visual data because of the movement and randomness that can occur at a cocktail hour more so than during a business meeting.

In Block 820 the IPS can selectively allow access to regions of the indoor space corresponding to the target object 128 (FIG. 1) identification permissions. The IPS can have levels of security clearance. In other embodiments, functionalities of the indoor space can be restricted. For example, an elevator can only be accessed by target objects precleared by the IPS and restrict others. In Block 822, the IPS can compute the trajectory of the target object according to user input, the angle 416 and range 414 (FIG. 1) determined by the IPS. Block 822 can also generate estimated time of arrival (ETA) and other predictive information. Block 822 can use neural networks or other technologies to produce a trajectory or other predictions.

In Block 824 the IPS can provide navigation services. The services can be in accordance with the computed trajectory. Alternatively, Block 824 can have the IPS perform preemptive actions for the target object 128 (FIG. 1) like open doors or turn on lights. In other embodiments, the IPS can prepare documentation corresponding to trajectory information. For example, a warehouse employee using a forklift can prepare documentation of the employee's daily activities and the forklift's usage.

In Block 826, the IPS displays information in a portal relating to the IPS. Information can include identifying personnel in the indoor space, the personnel's location, and other personnel associated with the first personnel in the indoor space as well as unverified guests. Block 826 can also interface with block 818 for alternate configurations of the IPS. In asset tracking uses, a user can set off a “ping” to identify lost or missing assets for usage or theft protection purposes. Block 826 and block 804 can also “ping” to identify a missing target object 128 if the target object 128 is in communication with IPS framework 100 (FIG. 1).

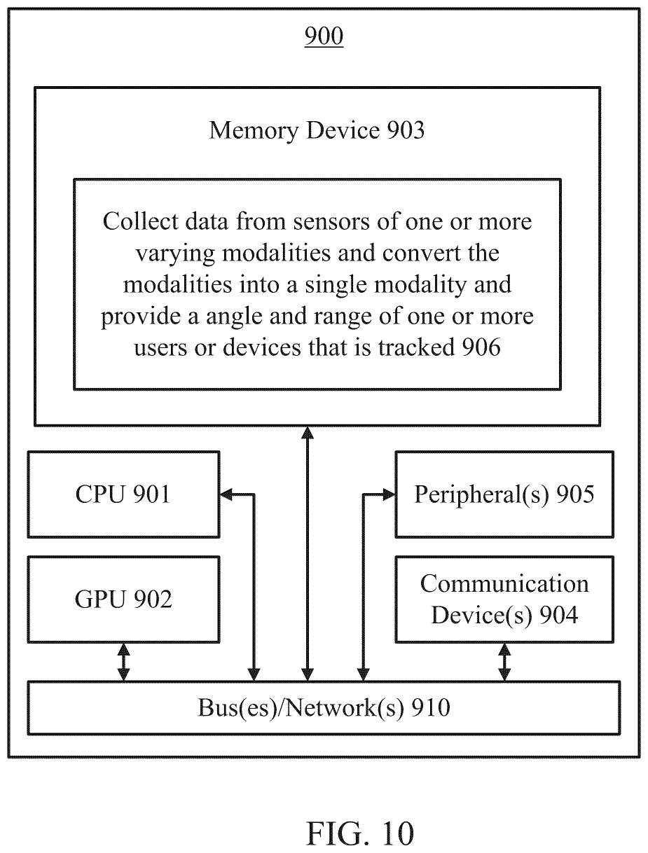

Referring to FIG. 10, a block diagram is shown for an exemplary processing system 900, in accordance with an embodiment of the present invention. The processing system 900 includes a set of processing units (e.g., CPUs) 901, a set of GPUs 902, a set of memory devices 903, a set of communication devices 904, and a set of peripherals 905. The CPUs 901 can be single or multi-core CPUs. The GPUs 902 can be single or multi-core GPUs. The one or more memory devices 903 can include caches, RAMs, ROMs, and other memories (flash, optical, magnetic, etc.). The communication devices 904 can include wireless and/or wired communication devices (e.g., network (e.g., Wi-Fi®, etc.) adapters, etc.). The peripherals 905 can include a display device, a user input device, a printer, an imaging device, and so forth. Elements of processing system 900 are connected by one or more buses or networks (collectively denoted by the figure reference numeral 910).

In an embodiment, memory devices 903 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 903 store program code or software 906 for implementing one or more functions of the systems and methods described herein for providing IPS services to target objects 128 (FIG. 1), where the IPS is modality agnostic proving for a variety of modalities to be used, and converting the information into range 414 and angle 416 (FIG. 4) data. The memory devices 903 can store program code for implementing one or more functions of the systems and methods described herein.

Of course, the processing system 900 may also include other elements (not shown), as readily contemplated by one of skill in the art, as well as omitting certain elements. For example, various other input devices and/or output devices can be included in processing system 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 900 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 900.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for indoor localization, comprising:
locating a target object in an indoor space by employing sensors of different modalities;
converting data from the sensors of different modalities into a single modality by employing a sensor-agnostic modality converter; and
determining from the data in the single modality a range of the target object from a fixed point to locate a position of the target object within the indoor space.

2. The method of claim 1, further comprising:
determining from the data in the single modality an angle of the target object from a fixed point to locate a position of the target object within the indoor space.

3. The method of claim 1, further comprising:
registering the target object to a network once a connection between the sensors and the network is established and assigning a registration status to the target object.

4. The method of claim 3, further comprising:
identifying the target object from the range and the registration status.

5. The method of claim 4, further comprising:
selectively allowing access to one or more of a plurality of regions of the indoor space to the target object to corresponding to the target object identification and a corresponding access level within the network.

6. The method of claim 1, further comprising:
computing a trajectory of the target object according to the range; and
providing navigation services to the target object based on the computed trajectory of the target object.

7. The method of claim 1, wherein the sensors further include at least one barometric sensor.

8. A system for method for indoor localization, comprising:
locating a target object in an indoor space by employing sensors of different modalities;
converting data from the sensors of different modalities into a single modality by employing a sensor-agnostic modality converter; and
determining from the data in the single modality a range of the target object from a fixed point to locate a position of the target object within the indoor space.

9. The system of claim 8, further comprising;
determining from the data in the single modality an angle of the target object from a fixed point to locate a position of the target object within the indoor space.

10. The system of claim 8, further comprising:
registering the target object to a network once a connection between the sensors and the network is established and assigning a registration status to the target object.

11. The system of claim 10, further comprising:
identifying the target object from the range and the registration status.

12. The system of claim 11, further comprising:
selectively allowing access to one or more of a plurality of regions of the indoor space to the target object to correspond to the target object identification and a corresponding access level within the network.

13. The system of claim 8, further comprising:
computing a trajectory of the target object according to the range; and
providing navigation services to the target object based on the computed trajectory of the target object.

14. The system of claim 8, wherein the sensors further include at least one barometric sensor.

15. A computer program product comprising a non-transitory computer-readable storage medium containing computer program code, the computer program code when executed by one or more processors causes the one or more processors to perform operations, the computer program code comprising instructions to:
locate a target object in an indoor space by employing sensors of different modalities;
convert data from the sensors of different modalities into a single modality by employing a sensor-agnostic modality converter; and
determine from the data in the single modality a range of the target object from a fixed point to locate a position of the target object within the indoor space.

16. The computer program of claim 15, further causes the processor to:
determine from the data in the single modality an angle of the target object from a fixed point to locate a position of the target object within the indoor space.

17. The computer program of claim 15, further causes the processor to:
register the target object to a network once a connection between the sensors and the network is established and assign a registration status; and
identify the target object from the range and the registration status.

18. The computer program of claim 17, further causes the processor to:
selectively allow access to one or more of a plurality of regions of the indoor space to the target object to correspond to the target object identification and a corresponding access level within the network.

19. The computer program of claim 15, further causes the processor to:
compute a trajectory of the target object according to the range; and
providing navigation services to the target object based on the computed trajectory of the target object.

20. The computer program of claim 15, wherein the sensors further include at least one barometric sensor.
